(19) United States
(12) Patent Application Publication
(10) Pub. No.: US 2006/0129313 A1
(43) Pub. Date: Jun. 15, 2006

(54) System and method for driving directions based on non-map criteria

(76) Inventors: Craig Henry Becker, Austin, TX (US); David Wayne Glass, Georgetown, KY (US); Steven Mastrianni, Unionville, CT (US); Clifford Alan Pickover, Yorktown Heights, NY (US)

Correspondence Address: Ido Tuchman;Suite 503, 69-60 108th Street, Forest Hills, NY, 11375, US

(21) Appl. No.: 11/011,356

(22) Filed: Dec. 14, 2004

(51) Int. Cl. G01C 21/34

(52) U.S. Cl. 701/202; 701/209; 340/995.19

(57) ABSTRACT

The present invention introduces the notion of a route provider that efficiently and automatically helps and rewards drivers for traversing optimal driving routes. In particular, described is a technique for receiving one or more conditions and criteria associated with map directions over a computer network from a service bureau. The route provider or a third party may reward drivers for traversing preferred routes.

### FIELD OF THE INVENTION

The present invention relates generally to map driving directions. More specifically, the invention relates to a service that facilitates the map driving directions and user rewards based in part on a variety of non-coordinate criteria.

### BACKGROUND

Travel direction web services, such as those available at the mapquest.com website, provide trip directions for people traveling by car from one address to another. MAPQUEST.COM is a registered trademark of MapQuest.com, Inc. Such services locate addresses through a process known as “geocoding”. Geocoding assigns a latitude-longitude coordinate to an address. Once a latitude-longitude coordinate is assigned, the address can be displayed on a map or used in a spatial search. Websites such as mapquest.com use a wide variety of information from many sources to provide geocoding, mapping and routing services. In addition to the major highways shown at various scales for countries around the world, these third party sources provide province, city and water boundaries as well as railroad lines for most countries. Third parties may also provide street maps, census data, postal geography, and topographic maps.

Although map direction services such as the mapquest.com website exist, these services typically focus on guiding people from one address to another based on street maps and generally do not consider ambient and non-street-map factors. Such ambient and non-street-map factors can be prevailing and forecasted weather conditions, the nature of a driver's car and car equipment (such as snow tires, weight of vehicle), time of day, holiday dates, gas prices, prevailing economic conditions (stock markets, etc.), number of people requesting map directions between two locations at a particular time, terrorist alert levels, nature of food stops along the way, elevation, historical record of traffic problems, number of traffic lights, number of police tickets given, accidents (predicted and current), weather predictions for dates supplied by the user, crime statistics, and the speed limits on each road in the path.

### SUMMARY OF THE INVENTION

The present invention addresses the above-mentioned limitations of the prior art by introducing a system that provides a user with a travel route and considers such ambient or “non-coordinate” factors such as: prevailing and forecasted weather conditions, vehicle characteristics (such as snow tires, weight of vehicle), time of day, holiday dates, gas prices, prevailing economic conditions (stock markets, etc.), number of people requesting map directions between two locations at a particular time, terrorist alert levels, nature of food stops along the way, elevation, historical record of traffic problems, number of traffic lights, number of police tickets given, accidents (predicted and current), weather predictions for dates supplied by the user, crime statistics, and the speed limits on each road in the path. Based on these criteria, the system may advise the traveler of optimal date and time to travel the route. Furthermore, the invention may be configured to provide a user with useful routes and may reward users for selecting and using certain routes.

The present invention can optimize a user's trip based on a user's profile that includes information about the user in conjunction with ambient and non-street-map factors. Various possible directions may be color coded on a map so that various possible choices are visually correlated with a number of non-street-map criteria.

Thus, one exemplary aspect of the present invention is a method for providing travel directions to a user. The method includes a receiving operation to obtain coordinate information from the user. Another receiving operation obtains non-coordinate information from at least one data source. A generating operation automatically generates at least one trip route based, at least in part, on the coordinate information and non-coordinate information.

Another exemplary aspect of the present invention is an automated route provider coupled to a client. The route provider includes a coordinate information receiving module configured to receive coordinate information from the client. A non-coordinate information receiving module is configured to receive non-coordinate information from at least one data source. A routing module is configured to generate a trip route based, at least in part, on the coordinate information and non-coordinate information.

Yet a further exemplary aspect of the invention is a computer program product configured to receive coordinate information from the user, receive non-coordinate information from at least one data source, and generate at least one trip route based, at least in part, on the coordinate information and non-coordinate information.

The foregoing and other features, utilities and advantages of the invention will be apparent from the following more particular description of various embodiments of the invention as illustrated in the accompanying drawings.

### BRIEF DESCRIPTION OF THE DRAWINGS

FIG. 1 shows an exemplary environment embodying the present invention.

FIG. 2 shows exemplary modules forming one embodiment of a route provider.

FIG. 3 shows a flowchart of system operations performed by one embodiment of the present invention.

FIG. 4 shows a table representing an exemplary data file used by a route provider to generate trip routes.

### DETAILED DESCRIPTION OF THE INVENTION

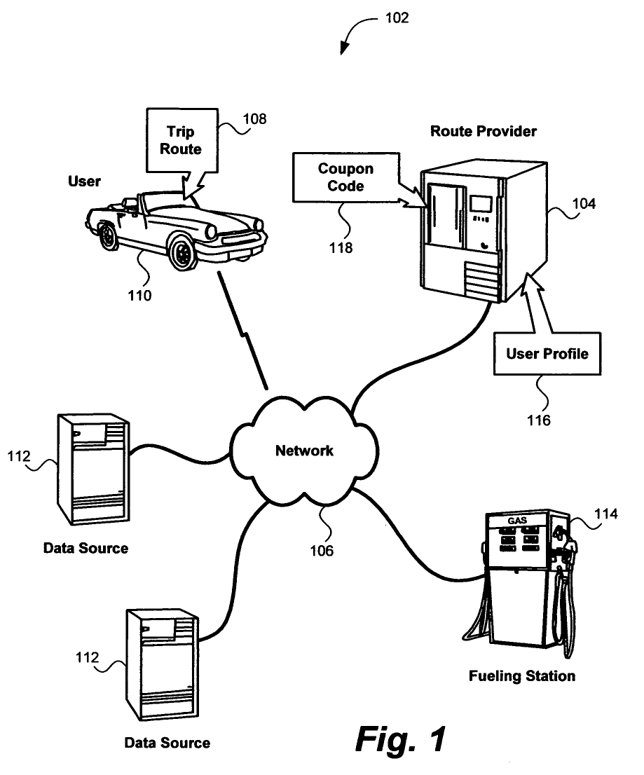

The following description details how the present invention is employed to calculate and convey map directions based on ambient and non-street-map factors, as well as optionally rewarding users for selecting and using certain routes. Throughout the description of the invention reference is made to FIGS. 1-4. When referring to the figures, like structures and elements shown throughout are indicated with like reference numerals.

FIG. 1 shows an exemplary environment 102 embodying the present invention. It is initially noted that the environment 102 is presented for illustration purposes only, and is representative of countless configurations in which the invention may be implemented. Thus, the present invention should not be construed as limited to the environment configurations shown and discussed herein.

The environment 102 includes a route provider 104 coupled to a network 106. As discussed in more detailed below, the route provider 104 is configured to provide one or more trip routes 108 to users 110 based on coordinate and non-coordinate information. The route provider 104 may additionally suggest an optimal departure time for a particular set of trip routes 108. A trip route 108 is a detailed description of a travel path and may be conveyed to a user 110 through various known output methods, such as paper printout, computer display, and synthesized speech.

Coordinate information is information traditionally used by travel direction web services, such as starting and ending addresses, and geocoded locations. Non-coordinate information, on the other hand, includes information such as an expected time of travel, prevailing weather conditions, forecasted weather conditions during the expected time of travel, user vehicle characteristics, holiday dates, fuel prices, toll prices, prevailing economic conditions, number of users requesting travel directions for travel during the expected time of travel, terrorist alert levels, nature of food stops, road elevation, historical record of traffic conditions, number of traffic lights, number of speeding tickets issued, historic number of traffic accidents, predicted number of traffic accidents, crime statistics, and the speed limits along the trip route.

The present invention introduces the notion of a route provider 104. As used herein, a route provider 104 may be a government or private entity that automatically helps drivers obtain optimal driving routes. The route provider 104 may additionally offer economic incentives for driving along predetermined these routes. It is contemplated that the route provider 104 may be a service executing locally on a user's computing device or as a remote service coupled to the user's computing device through a computer network 106, as a shown.

In a particular embodiment of the invention, the route provider 104 receives non-coordinate information from data sources 112 coupled to the network 106. For example, one data source may be a fueling station 114 in communication with the route provider 104. In this case, the route provider 104 may periodically receive prices for fuel offered at the fueling station 114. The fueling station 114 may also be configured to provide various other non-coordinate data to the route provider 104, such as the type of food service it offers (if any) and the road visibility and traffic conditions around the fueling station 104.

The route provider 104 may also store a user profile 116 containing, among other information, a preferred routing scheme. The preferred routing scheme lists which non-coordinate information is more important to the user in selecting a trip route. For example, the user 110 may indicate in the profile 116 that he or she prefers driving along routes with historically low traffic accidents over routes with high speed limits. Accordingly, the route provider 104 can factor in the user's personal travel preferences indicated by the user profile 116 when generating a trip route 108 for the user 110.

In another embodiment of the invention, the route provider 104 may offer economic incentives for users 108 to travel along the trip routes 108 generated. For example, the route provider 104 may issue a coupon code 118 entitling the user 108 to a price discount at a fueling station 114 along the trip route 108. The economic incentives may be valid for a particular time range, thereby further motivating the user 108 to travel along the trip route during a particular time window. Other examples of economic incentives contemplated by the present invention include a reduction in toll fee by municipalities for drivers that travel along trip routes generated by the route provider 104, and automobile insurance rate discounts by insurance companies for drivers that take historically safer trip routes generated by the route provider 104.

Governments may want to encourage less gasoline consumption, thus producing less pollution, and the states may provide credit for traveling certain routes. The information regarding accidents, police activity, etc., may be aggregated from different web sites to form an accurate “picture” of the surrounding area. Also, since government sites are aware of road construction projects and schedules, the system can guide drivers around troubled areas by getting data from the government sites and even could aggregate some weather information and perhaps guide users past certain attractions or landmarks. Users may make requests for the “scenic route” or “fastest possible route.” This system may facilitate financial gains to users if the information could get users to meetings on time.

It is contemplated that the network 106 may be any network known to those skilled in the art for effectuating communications between the various devices within the environment 102. For example, the network 106 may include wired and wireless communication capabilities. The network may be a pubic network, such as the Internet, or a private network, such as the OnStar® satellite network. ONSTAR is a registered trademark of General Motors Corporation, a Delaware company. Furthermore, the network 106 may utilize numerous communication protocols known to those skilled in the art, such as TCP/IP.

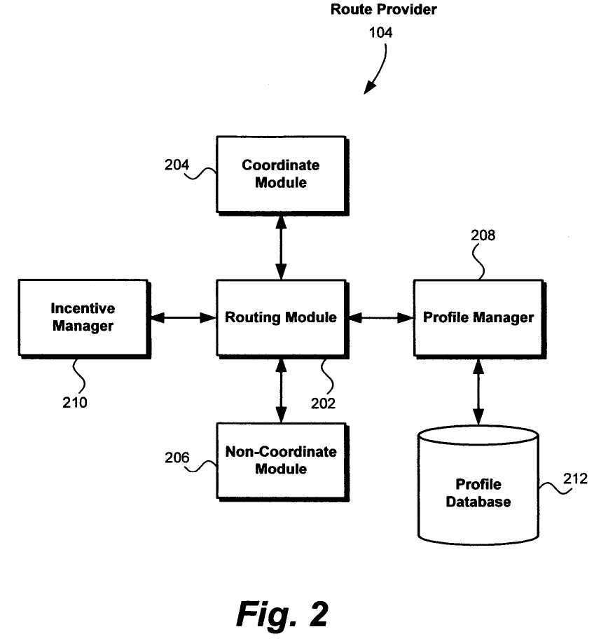

Turning to FIG. 2, exemplary modules forming one embodiment of the route provider 104 are shown. The modules shown may be implemented in hardware, software or as a combination of both. The implementation is a matter of choice dependent on the performance requirements of the system realizing the invention.

Central in the route provider arrangement is a routing module 202. The routing module 202 is configured to generate a trip route based, at least in part, on coordinate information and non-coordinate information. The coordinate information is obtained from a coordinate module 204, while non-coordinate information is received from a non-coordinate module 206. The routing module 202 may further utilize user profile information to create the trip route. In such a configuration, profile information is received from a profile manager 208.

The coordinate module 204 is configured to receive trip coordinates from the user. These coordinates may be in the form, for example, of street addresses, postal zip codes, geographic region, or latitude and longitude coordinates. The coordinate module 204 can use a database, conversion service, or other processing technique known to those skilled in the art to translate coordinates received by the user into geocoding.

The non-coordinate module 206 is configured to receive non-coordinate information from at least one data source. For example, the non-coordinate module 206 may contact a weather service to retreave weather information. Weather information includes current and predicted weather conditions about the temperature, wind speed, humidity, atmospheric pressure, sunset and sunrise times, rain, snow, fog, ice, flooding and the like along a particular strech of the trip route. In addition, the non-coordinate module 206 may receive statistical information from one or more data sources. Statistical information can include alert levels, toll prices, fuel prices, prevailing economic conditions, nature of food stops, road elevation, historical record of traffic conditions, road conditions (i.e., construction), number of traffic lights, number of speeding tickets issued, historic number of traffic accidents, predicted number of traffic accidents, crime statistics, and the speed limits along the trip route. It is contemplated that statistical information may be received from various governmental, non-profit, and private data services.

Some non-coordinate information maybe user supplied, such as whether a user's vehicle is a commercial vehicle and the height and weight of the user vehicle. This information may be used to rule out trip routes that restrict travel based on the height, weight or commercial purpose of vehicles. Furthermore, some non-coordinate information may be generated by the route provider 104 itself. For example, the route provider may keep track of the number of users requesting travel directions for travel during the expected time of travel and holiday dates.

The profile manager 208 is coupled to a profile database 212 that stores user profiles employed by the route provider 104. In addition to containing information about the user's home location and vehicle type, a user profile includes a preferred routing scheme based on non-coordinate information. The user profile may indicate that an optimal trip route should have an estimated travel time no slower than X-percent of the fasted possible trip route, where X is a value selectable by the user. In addition, the user profile may contain a list indicating the order of preference for selecting various routes. For example, the user profile may contain the following entry:

Avoid routes (in order of preference) with:

1. Historically high accidents

2. Low speed limits

3. Hazardous weather forecasted

It should be noted that other embodiments of the present invention may store user profiles at the user's computing device rather than at the route provider 104.

The routing manager 202 receives data from the coordinate module 204, non-coordinate module 206 and profile module 208, and generates one or more trip routes for the user utilizing the combined information. The route coordinator may additionally suggest an optimal trip departure time based on transient non-coordinate information such as weather and traffic conditions. Furthermore, the different routes generated may be color-coded such that color codes are configured to indicate the prominence of different non-coordinate information used in generating the different trip routes. Various routing schemes are known to those skilled in the art that can be utilized by the routing manager 202. Such routing schemes are outside the scope of the present invention. The trip route may be communicated to the user in various forms, such as a text description, pictorial display, voice message, and multimedia presentation.

In one embodiment of the invention, the routing module 202 is coupled to an incentive manager 210. The incentive manager 210 is configured to offer one or more economic incentives to the users to travel along a trip route. It is contemplated that economic incentives may be, for example, advertisements and/or price discounts for goods or service sold along a trip route. Furthermore, the incentive manager 210 may collect a commission from merchants featured in the economic incentive.

In another embodiment of the invention, a third party may pay for all or part of the route provider system. For example, a storeowner may wish to pay to have trip directions along his store. A government may pay the route provider 104 to suggest roads that do not produce congestion at a particular time of day or that, for example, avoid parades. A third party, such as a government or storeowner may offer incentives for traversing a particular path. Incentives may include discounts, coupons, cash, or services.

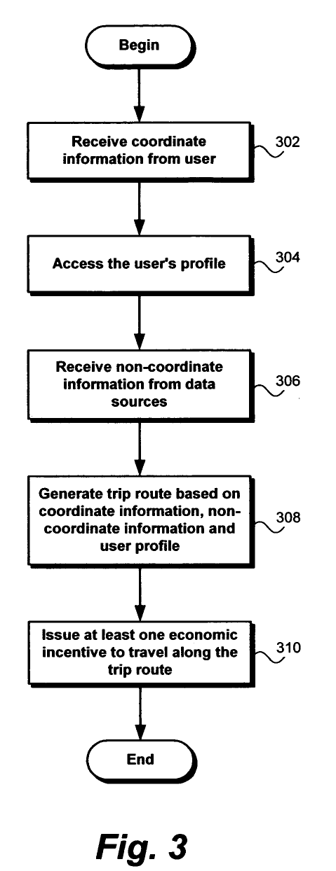

In FIG. 3, a flowchart of system operations performed by one embodiment of the present invention is shown. It should be remarked that the logical operations shown may be implemented (1) as a sequence of computer executed steps running on a computing system and/or (2) as interconnected machine modules within the computing system. As mentioned above, the implementation is a matter of choice dependent on the performance requirements of the system implementing the invention. Accordingly, the logical operations making up the embodiments of the present invention described herein are referred to alternatively as operations, steps, or modules.

Operational flow begins with receiving operation 302. During this operation, the route provider receives coordinate information from a user's computing device via a computer network. The coordinate information may be, for example, the start and destination locations for an upcoming trip. The computing device may reside in a car, in a user's home, in a store, or other public location. The computing device may include input means such as a keyboard, touch pad, and/or speech recognition unit through which a user may supply the desired destination for a trip. In some cases, coordinate information may be entered by a third party, such as a secretary for the user or by a software agent that is planning a trip for one or more users. Furthermore, the computing device may include output means to convey the trip route to the user, such as a video display, sound system, and/or printer. After receiving operation 302 is completed, process flow continues to accessing operation 304.

At accessing operation 304, the route provider checks the user information contained in the user profile. User profiles typically contain driver preferences and information about the driver's vehicle. The information in a user profile can also include user requests, such as “give me several scenic routes” or “give me the fastest possible route.” The user may also enter such information interactively in real-time. After accessing operation 304 is completed, control passes to receiving operation 306.

At receiving operation 306, the route provider receives non-coordinate information from one or more data sources. For example, the route provider may receive as input the prevailing and forecasted weather conditions for travel dates specified by a user. Such information is available over a network from various weather tracking agencies. This non-coordinate information can be helpful to a user wishing to avoid routes with predicted snow.

For a user wishing to minimize the cost of travel, the route provider may check for gas prices along a particular route. The route provider may further check prevailing economic conditions (stock markets, taxes, tax deductions, etc.). For example, sales taxes in different states may differ and affect the driving routes preferred by users. The route provider may further check tolls and find a route that minimizes toll charges.

For users wishing to avoid traffic, the route provider may check the number of people requesting map directions between two locations at a particular time. For example, if thousands of people are listing Disney World as a destination on a particular date through a certain set of roads, the route provider may suggest alternate routes to stay clear of traffic. The route provider may check the time of day for the route and suggest alternative routes so that a user can avoid traffic. The route provider may check the holiday dates for the route and suggest an alternative route so that a user can avoid holiday traffic congestion and for other purposes. The route provider may check the historical record of traffic problems in order to suggest routes that minimize this traffic.

Some users may employ the route provider to find the fastest route to a particular destination. For this objective, the route provider may check the number of traffic lights and duration of traffic light red signals along certain routes in order to suggest routes that avoid delays. Other relevant non-coordinate information includes the speed limits along the various roads used along a preferred trip route.

For those users concerned with safety, the route provider may request non-coordinate information such as the historical record of accidents along certain routes in order to suggest routes that avoid accidents. The route provider may check a terrorist alert level for drivers that may want to avoid certain locations that could be terrorist targets.

The route provider may check the nature of food stops along the way, and this information may interact with time of day information in order to supply the driver with preferred driving directions. The route provider may check the elevation of roads, which may be useful for drivers or passengers who have medical conditions sensitive to elevation. The route provider may check the number of police tickets predicted to be given based on historical records along certain routes in order to suggest routes that avoid tickets. The route provider may check crime statistics associated with locations along suggested routes so that drivers may avoid high crime areas. The route provider may check aspects of the scenery along routes so that drivers may obtain a scenic route.

After receiving operation 306 is completed, control passes to generating operation 308, where the route provider supplies one or more trip routes to the user based on information gained in operations 302, 304 and 306. In addition, the generating operation 308 may advise the traveler of an optimal date and time to travel one or more of the generated routes. For example, if the route provider determines that delays are likely on a certain date and time or with predicted weather conditions, the route provider will advise the user of an alternative date and time. It is contemplated that the driving directions and various characteristics of the driving routes and criteria may be visually indicated by color on a map. After generating operation 308 is completed, control optionally passes to issuing operation 310.

At issuing operation 310, the route provider issues to the user at least one economic incentive to travel along the trip route. A third party, such as a government agency or store owner may offer rewards for traversing particular travel paths, such as paths with low traffic, low accident rates, or paths that pass certain stores and malls. Rewards may include discounts, coupons, cash, or services. Insurance companies, governments, or parents of a young driver may prefer users to take different routes for a variety of reasons including safety reasons. Stores may want drivers to pass their shops in hopes of attracting more customers. Governments and local communities may wish to shape traffic patterns to avoid congestion or pollution. The route provider may assist such plans by providing directions and including incentives to use such directions. A driver's compliance with a particular traversal can be monitored using, for example, coupons redeemable at specific locations, global positioning services, through tolls, easy pass, and other indicators. After issuing operation 310 is completed, the process ends.

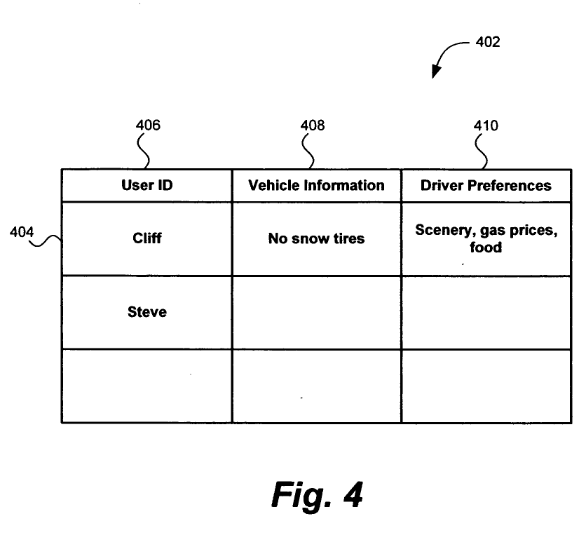

FIG. 4 shows a table 402 representing an exemplary data file used by the route provider to generate trip routes. The data file is preferably stored at the route provider, however it is contemplated that some information may be stored at the user's computing device. Each row 404 in the table 402 represents a user record. Furthermore, each user record includes user ID 406, vehicle information 408, and driver preferences 410 fields.

The user ID 406 may be a unique alphanumeric string identifying the user and can act as a key for the data file. Typically, the user transmits an identifier to the route provider, such as a login name, which the route provider tries to match with a user ID 406 in the data file. This saves the user from having to resubmit the same information over and over again to the route provider.

The vehicle information 408 may include information related to the nature of user's car. For example, the vehicle information may indicate characteristics such as all-wheel drive, snow tire equipped, and weight and height. This information is useful because vehicle characteristics may affect the route preference of the driver. For example, a user without snow tires may wish to avoid snowy roads.

Driver preferences 410 include various characteristics in trip routes that the user has predilections for. A user may indicate, for example, a preference for scenic routes, fastest possible routes, cheapest routes, routes with food and/or rest stops every thirty miles, and other preferences relevant to the routing module.

It is contemplated that the system can determine and display one or more suggested driving routes based on a variety of criteria mentioned and in numerous ways. For example, a user may enter a starting point S and destination point D on a map. The system may determine that there are several different viable routes between points S and D using known methods for route determination. Next, the system assesses the relative favorableness of the possible routes based on various non-coordinate information, such as weather and traffic forecasts. In particular, the system may assign attributes A for each road segment along the route as a function of time. The system may also assign a weight W at a given time t, so that for each road segment along the route, the system evaluates a function such as,
f(t)=A₁(t)*W₁(t)+A₂(t)*W₂(t)+ . . . Aₙ(t)*Wₙ(t)

In order to give the potential traveler a relative indication of route favorableness according to time of day, the system evaluates this function for a range of time values t, starting at a given time to and progressing through end time tₙ, incremented by some arbitrary amount of time, such as 15 minutes. Attribute data may be uploaded from various data sources such as real-time weather and traffic databases. Naturally, not all attributes will be available for every road segment, and missing attributes need not contribute to f(t).

A higher value for W indicates a greater importance of a particular attribute in determining the favorableness of a route. For example, if a driver has snow tires (e.g., as indicated in the vehicle information 408), W may decrease relative to a driver who does not have snow tires. Truckers and motorcycles may have different needs. People of different ages and driving skills may likewise have different needs. Weights may be assigned and controlled by the user, route provider, and/or third parties such as an insurance company.

The generated values for f(t) for each route from start to destination may be examined and sorted using known methods for finding the maximum and minimum values, and these values can be compared, ranked, and visualized. Once f(t) is computed for several possible paths, the system may display maps that are labeled for different times of the day, using, for example, color to indicate the favorableness of the routes. For instance, the favorableness of routes may be indicated by a gradient color scale that ranges from green to red, with green being best, red worst. A route may be green at one time of the day but shift towards red at another time as a result of weather and traffic forecasts, since the user may see maps at different times of day.

The foregoing description of the invention has been presented for purposes of illustration and description. It is not intended to be exhaustive or to limit the invention to the precise form disclosed, and other modifications and variations may be possible in light of the above teachings. For example, the route provider may be embodied in various tangible media know in the art, including, but not limited to, read only memory, random access memory, data streams, optical and magnetic memory, and the like. The embodiments disclosed were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

1. A method for providing travel directions to a user, the method comprising:
receiving coordinate information from the user;
receiving non-coordinate information from at least one data source; and
automatically generating at least one trip route based, at least in part, on the coordinate information and non-coordinate information.

2. The method of claim 1, wherein receiving non-coordinate information includes receiving at least one of: current weather conditions, predicted weather conditions, alert levels, toll prices, fuel prices, prevailing economic conditions, nature of food stops, road elevation, historical record of traffic conditions, road conditions, number of traffic lights, number of speeding tickets issued, historic number of traffic accidents, predicted number of traffic accidents, crime statistics, and the speed limits along the trip route.

3. The method of claim 1, further comprising issuing to the user at least one economic incentive to travel along the trip route.

4. The method of claim 3, wherein the economic incentive is an advertisement for goods or services offered for sale along the trip route.

5. The method of claim 3, wherein the economic incentive is a price discount for goods or services offered for sale along the trip route.

6. The method of claim 3, further comprising collecting a commission from merchants featured in the economic incentive.

7. The method of claim 1, further comprising:
accessing a user profile, the user profile including a preferred routing scheme based on the non-coordinate information; and
wherein generating the trip route is further based on the user profile.

8. The method of claim 7, wherein the user profile includes user vehicle characteristics.

9. The method of claim 1, further comprising color-coding different trip routes, wherein color codes are configured to indicate the prominence of different non-coordinate information used in generating the different trip routes.

10. The method of claim 1, further comprising suggesting an optimal travel departure time based on transient non-coordinate information.

11. An automated route provider coupled to a client, the route provider comprising:
a coordinate information receiving module configured to receive coordinate information from the client;
a non-coordinate information receiving module configured to receive non-coordinate information from at least one data source; and
a routing module configured to generate a trip route based, at least in part, on the coordinate information and non-coordinate information.

12. The route provider of claim 11, further comprising an incentive manager configured to issue to the client one or more economic incentives to travel along the trip route.

13. The route provider of claim 12, wherein the economic incentives are advertisements for goods or services offered for sale along the trip route.

14. The route provider of claim 12, wherein the economic incentives are price discounts for goods or services offered for sale along the trip route.

15. The route provider of claim 11, wherein the routing module is configured a evaluate a function:
f(t)=A₁(t)*W₁(t)+A₂(t)*W₂(t)+ . . . Aₙ(t)*W₁(t)
wherein A is an non-coordinate information attribute for a segment of the trip route, W is a weighting factor for the segment, and t is time.

16. A computer program product embodied in a tangible media comprising:
computer readable program codes coupled to the tangible media for providing travel directions to a user, the computer readable program codes configured to cause the program to:
receive coordinate information from the user;
receive non-coordinate information from at least one data source; and
generate at least one trip route based, at least in part, on the coordinate information and non-coordinate information.

17. The computer program product of claim 16, wherein the program code configured to cause the program to receive non-coordinate information includes program code configured to cause the program to receive at least one of: current weather conditions, predicted weather conditions, alert levels, toll prices, fuel prices, prevailing economic conditions, nature of food stops, road elevation, historical record of traffic conditions, road conditions, number of traffic lights, number of speeding tickets issued, historic number of traffic accidents, predicted number of traffic accidents, crime statistics, and the speed limits along the trip route.

18. The computer program product of claim 16, further comprising program code configured to cause the program to issue to the user at least one economic incentive to travel along the trip route.

19. The computer program product of claim 18, wherein the economic incentive is an advertisement for goods or services offered for sale along the trip route.

20. The computer program product of claim 18, wherein the economic incentive is a price discount for goods or services offered for sale along the trip route.

21. The computer program product of claim 18, further comprising program code configured to cause the program to collect a commission from merchants featured in the economic incentive.

22. The computer program product of claim 16, further comprising program codes configured to cause the program to:
access a user profile, the user profile including a preferred routing scheme based on the non-coordinate information; and
wherein the program code configured to cause the program to generate the trip route is further based on the user profile.

23. The computer program product of claim 22, wherein the user profile includes user vehicle characteristics.

24. The computer program product of claim 16, further comprising program code configured to cause the program to color-code different trip routes, wherein color codes are configured to indicate the prominence of different non-coordinate information used in generating the different trip routes.

25. The computer program product of claim 16, further comprising program code configured to cause the program to suggest an optimal travel departure time based on transient non-coordinate information.
